(19) United States
(12) Patent Application Publication
(10) Pub. No.: US 2016/0085840 A1
(43) Pub. Date: Mar. 24, 2016

(54) Universal Interaction for Capturing Content to Persistent Storage

(71) Applicant: Microsoft Corporation, Redmond, WA (US)

(72) Inventors: Madhur Dixit, Hyderabad (IN); Chinmay Vaishampayan, Hyderabad (IN); Justin Varacheril George, Hyderabad (IN); Nirav Ashwin Kamdar, Hyderabad (IN); Deepak Achuthan Menon, Hyderabad (IN); Srinivasa V. Thirumalai-Anandanpillai, Hyderabad (IN); Ramindar Singh Khatra, Hyderabad (IN); Xuedong Huang, Bellevue, WA (US); Akshad Viswanathan, Hyderabad (IN)

(73) Assignee: Microsoft Corporation, Redmond, WA (US)

(21) Appl. No.: 14/492,635

(22) Filed: Sep. 22, 2014

(51) Int. Cl. G06F 17/30; H04L 29/08; G06F 3/0481

(52) U.S. Cl. CPC G06F 17/30589; G06F 3/0481; H04L 67/1097

(57) ABSTRACT

Systems and methods for enhanced content capture on a computing device are presented. In operation, a user interaction is detected on a computing device with the intent to capture content to a content store associated with the computer user operating the computing device. A content capture service is executed to capture content to the content store, comprising the following: applications executing on the computing device are notified to suspend output to display views corresponding to the applications; content to be captured to the content store is identified and obtained; the applications executing on the computing device are notified to resume output to display views; and automatically storing the obtained content in a content store associated with the computer user.

### BACKGROUND

Computer users make use of a number of online resources, often using numerous applications or apps, to accomplish various tasks. For example, a couple wishing to travel to a foreign destination may perform a number of online research activities regarding the desired destination, including exploring housing options, dining choices, car rentals, attractions and activities at the destination, passport and/or visa requirements, airfare options, currency exchange, and the like. In all of these, a computer user is presented with a lot of information, some of which is valuable to the user and it would be desirable to capture the content into a persistent storage for future reference.

Generally speaking, a computer user is often able to save desirable content (in some form or another) through the current application. However, the computer user must make use of existing “save” features that may or may not adequately capture the desired content. Moreover, under existing save features, the computer user must select among multiple data storage solutions and options, such as one or more storage devices on the computer user's device, cloud storage solutions (such as Microsoft's OneDrive®), multiple folders, file name extensions, and the like, and each of these often present a cumbersome way to store content. Further still, there are different ways to deal with storage of different types of data. This mish-mash of storage features results in the computer user needing to understand how to deal with storage of different types, storing in an appropriate format, file naming rules, and the like. Clearly, current methods of persisting content significantly add to the cognitive load of a computer user. Further, the variety of current content capture and persisting options reduce the probability of that the computer user will be able to recall saved/persisted content at a future point in time.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods for enhanced content capture on a computing device are presented. In operation, a user interaction is detected on a computing device with the intent to capture content to a content store associated with the computer user operating the computing device. A content capture service is executed to capture content to the content store, comprising the following: applications executing on the computing device are notified to freeze or suspend output to display views corresponding to the applications; content to be captured to the content store is identified and obtained; the applications executing on the computing device are notified to resume output to display views; and automatically storing the obtained content in a content store associated with the computer user.

According to additional aspects of the disclosed subject matter, a computer-implemented method for capturing content on a computing device is presented. The method comprises first detecting a user interaction on the computing device, the user interaction indicating the computer user's intent to capture content to a content store associated with the computer user. A content capture service is executed to capture content to a content store. The content capture service, in execution, includes notifying applications executing on the computing device to suspend output to display views corresponding to the applications. Content of an application of the notified applications is identified as content to be captured to the content store. The content is obtained and stored in the content store. Moreover, the applications executing on the computing device are notified to resume output to display views.

According to still further aspects of the disclosed subject matter, a computing device for enhanced capturing content to a content store is presented. The computing device comprises a processor and a memory, where the processor executes instructions stored in the memory as part of or in conjunction with additional components to capture content to a content store. The additional components include an executable content capture component. In operation, the content capture component detects a user interaction on the computing device indicative of a computer user's intent to capture content to a content store associated with the computer user. Additionally, the content capture component notifies one or more applications executing on the computing device to suspend output to display views corresponding to the one or more applications, identifies content of an application of the notified applications as content to be captured to the content store, and obtains the identified content from the application via an application programming interface. Thereafter, the content capture component automatically, and without computer user interaction, stores the obtained content in a content store associated with the computer user and notifies the one or more applications executing on the computing device to resume output to display views.

In additional aspects of the disclosed subject matter, in addition to capturing all of the content of a current execution context, a user interface may be provided by which a computer user may, through the user interface, identify one or more portions of an entire body of content which the user desires to capture. Using the same interaction for capturing content, the identified portion of content is captured to persistent storage.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIGS. 1A and 1B are pictorial diagrams illustrating exemplary embodiments of a computing device including a content capture service/process;

FIG. 2 is a flow diagram illustrating an exemplary routine for implementing a content capture service on a computing device;

FIGS. 3A and 3B are pictorial diagrams illustrating an exemplary computing device display and for illustrating exemplary user interaction to capture content from the current execution context;

FIGS. 4A-4C are pictorial diagrams illustrating an alternative, exemplary computing device display and for illustrating exemplary user interaction to capture content from the current execution context;

FIGS. 5A-5B are pictorial diagrams illustrating another alternative, exemplary computing device display and for illustrating exemplary user interaction to capture content from the current execution context; and

FIG. 6 is a block diagram illustrating an exemplary computing device suitably configured with a content capture service.

### DETAILED DESCRIPTION

For purposes of clarity, the term “exemplary” in this document should be interpreted as serving as an illustration or example of something, and it should not be interpreted as an ideal and/or a leading illustration of that thing.

The term “content” refers to items and/or data that can be presented, stored, arranged, and/or acted upon. Often, but not exclusively, content corresponds to data/items that can be presented to a computer user via a computing device. Examples of content include, by way of illustration and not limitation, data files, images, audio, video, Web pages, user posts, data streams, and the like, as well as portions thereof. Content may be persisted/stored in one or more formats. Additionally, persisting content may comprise storing the content itself in a data store and/or storing a reference to the content in the data store.

The term “capture” or “capturing,” when used in the context of “capturing content,” refers to creating a record in a persistent data store. The record may contain one or more formats of the content and/or a reference to the content. Often, but not exclusively, a version (format) of the content that is most robust, such that other formats may be generated from the robust version, is recorded in the persistent data store. As will be discussed below, as part of capturing content, metadata of the content may also be captured and stored in the record. This metadata includes information such as a semantic understanding of the content, semantic relationships and data structures, source of the content, date that the content was persisted, and the like.

Regarding the terms “application” and “app,” an application refers to a body of software code/instructions designed to carry out one or more operations by way of the computing device upon which the application is executing. Similarly, an app is also body of software code/instructions designed to carry out one or more operations by way of the computing device upon which the application is executing. Typically, but not exclusively, an app is more narrowly focused on performing a small set of tasks whereas an application will have a larger focus and scope. While the terms app and application are frequently mentioned separately in this document, the differences between an app and an application, with respect to capturing content to a content store, that such differences are almost meaningless. Accordingly, while the terms app and application may be mentioned separately in the disclosure document (as they do have some differences), for purposes of the capturing content to a content store (as disclosed in this document) they should be viewed as synonymous.

As indicated above, capturing or persisting content is an important activity for computer users in the modern day. Content may include, by way of illustration and not limitation, images and videos, audio recordings, Web pages, email messages, text messages, files and documents, confirmation receipts, and the like. As mentioned above, various items of content may be the product of and related to significant, lengthy digital activity that a computer user is performing (such as researching the potential of traveling to a desired destination.) Alternatively, desirable content (that a computer user wishes to capture) may be the product of serendipity: e.g., encountering an article on the Web that the computer user would like to access or references at a later time.

As will be readily appreciated, individual applications typically (though not always) include a file save option in which the user must initiate a file save feature through a series of menu choices. As part of the typical file save option, the user must also identify information regarding drive volumes, folders, file names, and the like. Of course, some applications do not provide the ability to capture and/or save content. There are, of course, applications that can be used to capture the current display of an application, but such applications require that the user switch execution contexts e.g., switch from a current application to a “capture screen” application) in order to capture the displayed content. Even these applications are limited: they do not capture the underlying information but rather the results that are displayed on the computer's display screen.

In contrast to existing solutions, the disclosed subject matter presents an operating system-level service for capturing content. Advantageously, an operating system-level service can be accessed from within an execution context and functions without changing the execution context. In other words, a content capture service, being an operating system-level service, can be used from within an executing application without changing the execution context (switching to another application). Of course, it should be appreciated that the disclosed operating system-level service need not be implemented as a function of the operating system of a computing device, but rather that the service may be invoked in the same manner from all execution contexts and function as an extension of the current execution context, so that the execution context is not changed. In various embodiments, the content capture service, functioning as an operating system-level service, operates in a modal manner, though modal operation is not a mandatory feature.

Another advantage realized by the content capture service is that the service is independent of an application or app on a computing device. While the content capture service may be implemented by a third party or, alternatively, by the provider of the operating system, the content capture service is implemented such that it may be accessed from any application executing on the computing device for capturing content from any or all of the applications executing on the computing device. In other words, a computer user may invoke the content capture service by a system-wide, predefined user interaction (e.g., a predetermined gesture, a predetermined keystroke sequence, a hardware button or control, etc.) such that the interaction is independent of any app/application context. Moreover, as will be discussed in greater detail below, the content capture service is invoked through a common user interface across all execution contexts.

According to aspects of the disclosed subject matter, the content capture service negotiates with an app/application via an application programming interface (API) to capture rich content currently accessibly in the application. This metadata includes, by way of illustration and not limitation, file name, universal resource locator (URL) of the source of the content, application from which the content is captured, format of the captured content, available formats from the application, date the content was captured, and the like. In some instances, the computer user is provided with an option as to the format or nature of the content that is to be captured. For example, when viewing a Web location, a computer user may be presented with the option of capturing the Web page or the URL of the Web page, or both. Or the computer user may be presented with capturing a particularly relevant segment of a Web page. Similarly, when attempting to capture content from a media presentation application displaying a video file, the user may be presented with the option to capture the video, a segment of the video, a snapshot of the displayed video, the name and source of the video, and the like.

According to aspects of the disclosed subject matter, when capturing content, the content capture service stores/persists the captured content in a content store on behalf of the computer user. Advantageously, while the computer user is provided with the ability to configure elements of where the content capture service persists the captured content, at the time of capturing content the computer user does not need to specify the location of the captured content—it is automatically handled by the content capture service according to the previous configuration settings or according to the context present in the content. Advantageously, the content capture service may be configured to store the captured content in a network-accessible location such that the content is accessible to the computer user irrespective of the computing device that the computer user is currently operating.

The content capture service may be configured to create an entry for the captured content in the content store or, in some circumstances, update the content previously captured and stored in the content store. The content capture service may use the metadata regarding the captured content (such as file name, source URL, and the like) to determine whether captured content is to be added as a new record for the user in the content store or whether captured content relates to an existing record in the content store and should be updated.

In order to provide efficient, subsequent access to the captured content, the content capture service uses key terms and information from both the captured metadata and captured content as indices in an index regarding the captured content. In short, the key terms and information are used in an index to readily identify and/or retrieve the captured content from the content store.

As will be discussed below, when invoked the content capture service may cause the display of an app/application or multiple apps/applications to freeze such that the content capture service can captured desired content. In various embodiments, in addition to freezing the display of content of an app/application, the content capture service may be configured to allow the user to cycle through a z-order of displayed content in order to identify one or more apps/applications from which content is to be captured.

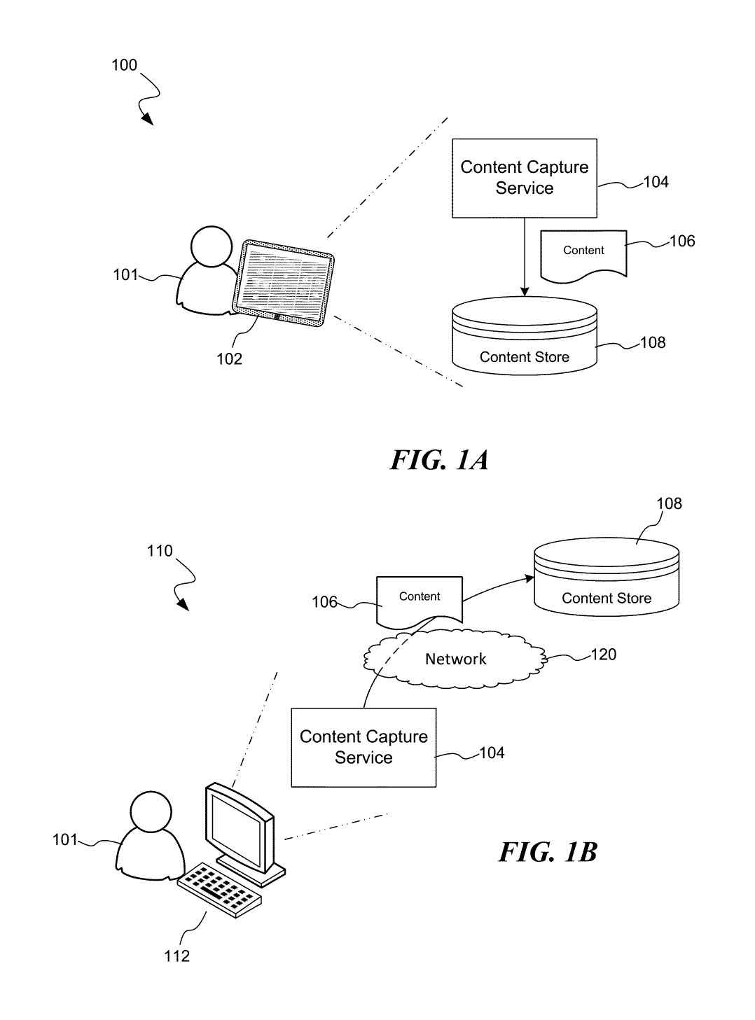

Turning now to the figures, FIGS. 1A and 1B are block illustrating exemplary embodiments of the disclosed subject matter. In particular, FIG. 1A illustrates an exemplary embodiment 100 of a computing device 102 associated with a computer user 101 being configured with a content capture service. While computing device 102 is illustrated as a tablet computer, it should be appreciated that this is illustrative of one embodiment and should not be viewed as being limiting upon the disclosed subject matter. Suitable computing devices for implementing aspects of the disclosed subject matter include, by way of illustration and not limitation, tablet computers, laptop computers, desktop computers, mini- and mainframe computers, smart phones, the so-called “phablet” computers (i.e., those computers that have the combined features of smartphones and tablet computers), console computing devices including game consoles, and the like.

As shown, the exemplary computing device 102 includes a content capture service 104 executing as an operating system-level service. In response to a user command for interacting with the content capture service 104, the content capture service captures content 106 and stores the content in a content store 108. As shown in FIG. 1A, the content store 108 may reside on the computing device 102, but this is illustrative and not a mandatory configuration aspect.

FIG. 1B presents an alternative exemplary embodiment 110 that includes a user computer 112 associated with the computer user 101. As above, the user computer 112 includes a content capture service 104 executing as an operating system-level process. In contrast to FIG. 1A, the content capture service 104 captures content 106 and stores the content in a remotely located content store 108 over a network 120. While, according to some embodiments, the content store may be located on the computing device, according to alternative embodiments by locating the content store 108 in a location that is remote from the computing device 112, the content store may be made available to the computer user 101 independent of whether or not the particular computing device, such as computing device 102, is online or not and/or is accessible or not. In this manner, irrespective of the computing device that a computer user currently employs, the computer user's content store is accessible—both for storing content and for accessing content stored in the content store 108. Moreover, in yet further embodiments (not shown), the captured content may be temporarily locally stored until and asynchronously uploaded and stored in a remote content store.

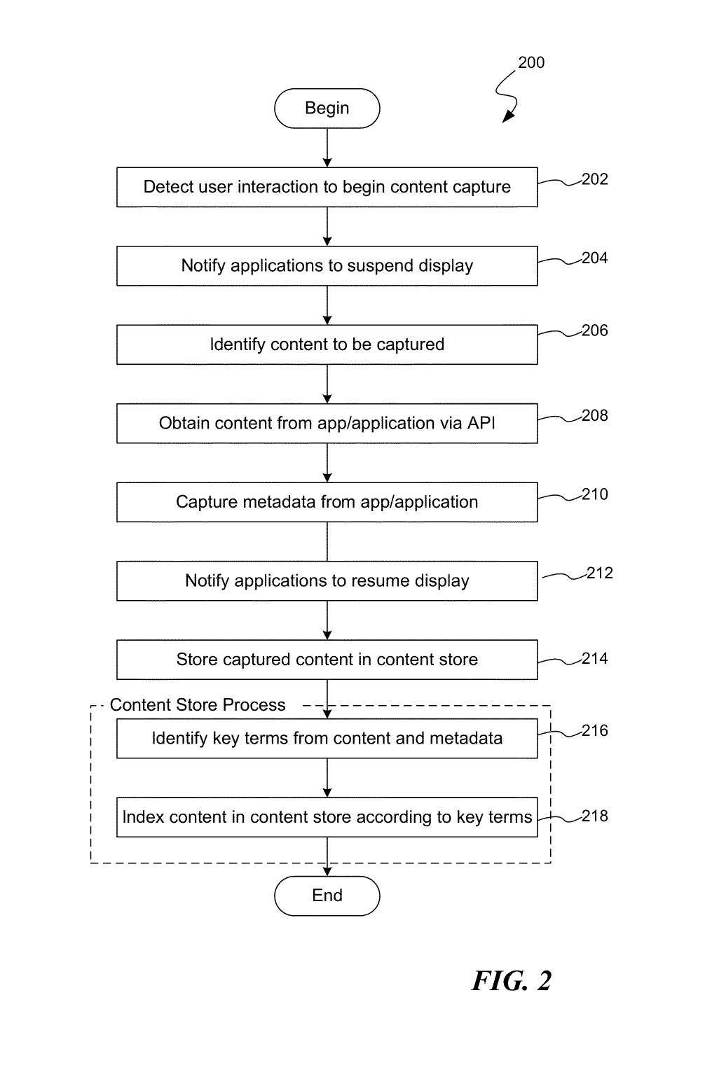

Turning to FIG. 2, FIG. 2 is a flow diagram of an exemplary routine 200 for capturing content on a computing device, such as computing device 200. Beginning at block 202, the content capture service 104 executing on the computing device detect a user interaction that triggers the beginning of a content capture operations. As will be discussed in greater detail below, the user interaction that triggers the beginning of a content capture operation may comprise any number of user interactions. The user interaction may include, by way of illustration and not limitation, a swipe gesture on a touch-sensitive input device (such as the surface of a tablet computer or smartphone), a predetermined key-press sequence, a hardware button or control, an audio command (as detected by a sound-sensitive device that converts sound to one or more electronic signal), a predetermine mouse click (separately or in combination with a key-press and/or a mouse button press), an optically sensed action or gesture (as detected by an optical sensor that converts the optically sensed activity to one or more electronic signals), a physically sensed motion (e.g., through an accelerometer or other motion sensing device), and the like.

After the content capture service is begun (to capture content), at block 204 the routine 200 notifies (or sends out a command to) executing apps and applications to suspend displaying or updating displayed content while the content capture service 104 captures content for the computer user. According to aspects of the disclosed subject matter, notifying the apps and/or applications executing on the computing device to suspend displaying or updating content on a display may include implementing a block that prohibits the apps/applications from displaying content (or updating content) on a display view.

At block 206, the routine 200 identifies the content to be captured. According to aspects of the disclosed subject matter, the content may be identified according to the current execution context, may be identified by the user after the content capture process has begun—either by explicit selection by the user or automatic selection according to the context (including execution context), and the like. By way of illustration and not limitation, a computer user may trace out an area of content on a display device or touch surface, thereby defining the content (within the traced area) to be captured. As another non-limiting alternative, the computer user may use a predefined interaction to indicate that all of the content in the current execution context/application is to be captured.

At block 208, the identified content is obtained or captured from an app/application execution on the computing device. Typically, though not exclusively, the content is captured by way of an API in which the content capture process can interact with the app or application. For example (by way of illustration and not limitation), the content capture service 104 may be able to determine the context from the app/application without interaction through and API, or have predetermined information regarding common apps/applications. At block 210, in addition to capturing the content, metadata is also captured regarding the content. This metadata may include, by way of illustration and not limitation, the application from which the content is captured, the available format of content from the app/application, the date the content was created, a URL identifying the source of the content, a filename of the content, and the like.

After capturing the content and the metadata, at block 212 the routine 200 notifies the currently executing applications that they can resume displaying content on the computing device. According to aspects of the disclosed subject matter, this notification to resume may include releasing a block that prevents the applications from updating their display screens. At block 214, the identified content and associated metadata are stored in the content store 108.

While not shown, in various configurations and embodiments, the computer user may be provided with an opportunity to confirm that the identified content is the content that the computer user intended to capture. This computer user interaction is made to identify/confirm the content to be captured, however, and not to specify a particular location, file format, or the like. Thus, unlike most file save operations, identified content is stored automatically and without user interaction in the content store, greatly enhancing the ability of a user to store content in a consistent location, and further enhancing the ability of the computer user to access that content at a future time since the content is stored in a consistent location and, as will be discussed below, indexed according to key terms, information, and attributes of the captured content.

In addition to storing the captured content in a content store 108, at block 216 key terms and information regarding the captured content and metadata are identified. At block 218, the key terms and information are then used as indices to the content in a content index for subsequent retrieval. It should be appreciated, however, that while the exemplary content capture process 104 may perform the identification of key terms and information, as well as adding the terms to a content index, as identified in blocks 216 and 218, these steps may alternatively be processed by an external, cooperative content store process that manages the content store 108 for the computer user. Moreover, according to various embodiments of the disclosed subject matter, while not shown, the cooperative content store process may also manage a content store for a plurality of other users.

After adding the content to the content store, the routine 200 terminates.

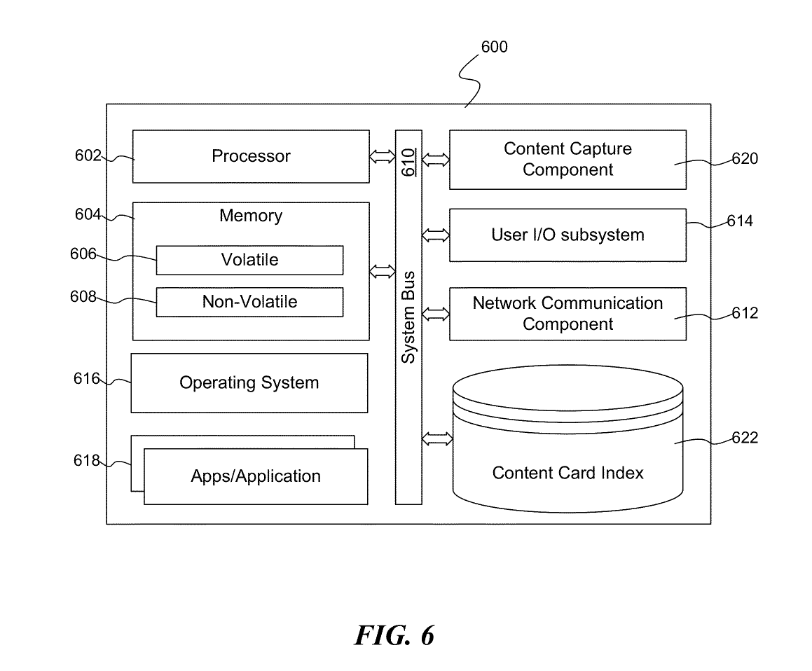

Regarding routine 200 described above, as well as other processes describe herein, while these routines/processes are expressed in regard to discrete steps, these steps should be viewed as being logical in nature and may or may not correspond to any actual and/or discrete steps of a particular implementation. The order in which these steps are presented in the various routines and processes should not be construed as the only order in which the steps may be carried out. In some instances, some of these steps may be omitted. Moreover, while these routines include various novel features of the disclosed subject matter, other steps (not listed) may also be carried out in the execution of the routines. Those skilled in the art will appreciate that logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on computing devices, such as the computing device described below in regard to FIG. 6. In various embodiments, all or some of the various routines may also be embodied in executable hardware modules, including but not limited to system on chips, specially designed processors and or logic circuits, and the like on a computer system.

These routines/processes are typically implemented in executable code comprising routines, functions, looping structures, selectors such as if-then and if-then-else statements, assignments, arithmetic computations, and the like. However, the exact implementation in executable statement of each of the routines is based on various implementation configurations and decisions, including programming languages, compilers, target processors, operating environments, and the link. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied in applications (also referred to as computer programs), apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions that are stored on the computer-readable storage devices are executed, they carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

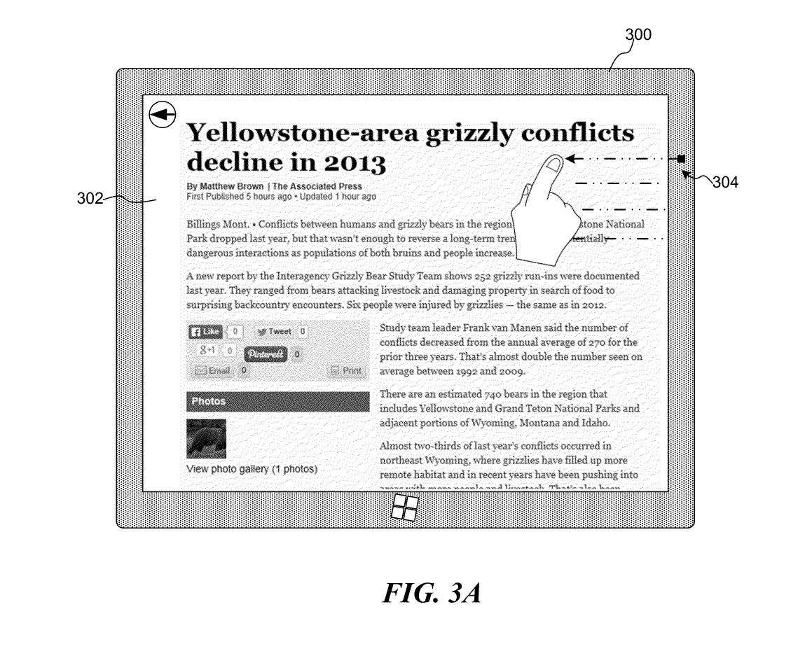

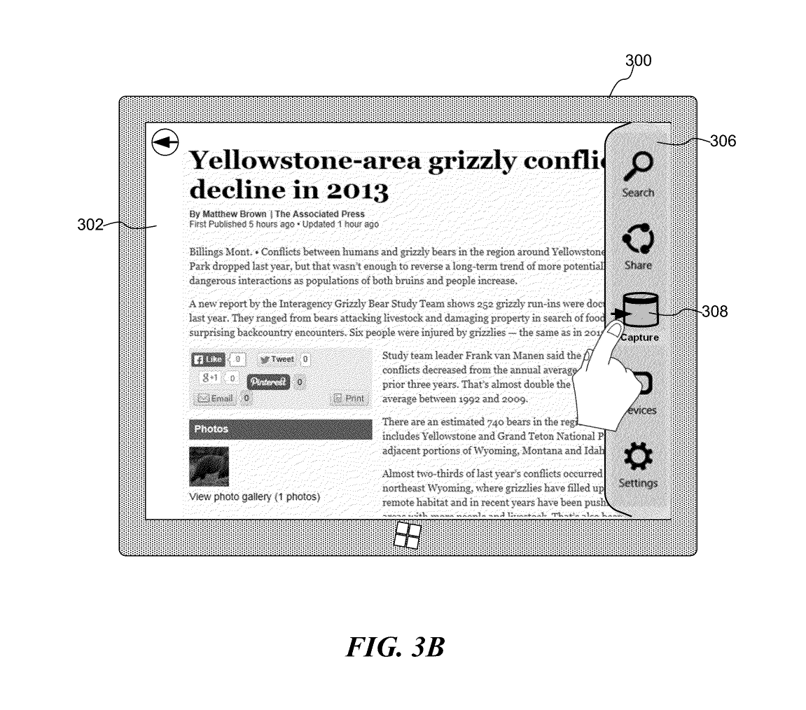

Turning now to FIGS. 3A and 3B, these figures are pictorial diagrams of an exemplary computer display 300 and for illustrating exemplary user interaction to capture content from the current execution context. As can be seen, the exemplary computer display 300 current displays content 302 that the computer user is currently viewing without changing the current execution context on the computing device. Assuming that the computer user wishes to capture the content, in this illustrative example the user touches at the side 304 of the display screen 300 and swipes inward. Yet another triggering interaction on a touch screen may include (again by way of illustration and not limitation) double tapping the screen. In response, and as illustratively shown in FIG. 3B, various operating system-level options are presented to the computer user on an options view 306, including a capture option 308 for invoking the content capture process 104. By selecting the capture option 308, the content 302 is captured to the content store 108, the options view is dismissed, and execution continues in the current execution context.

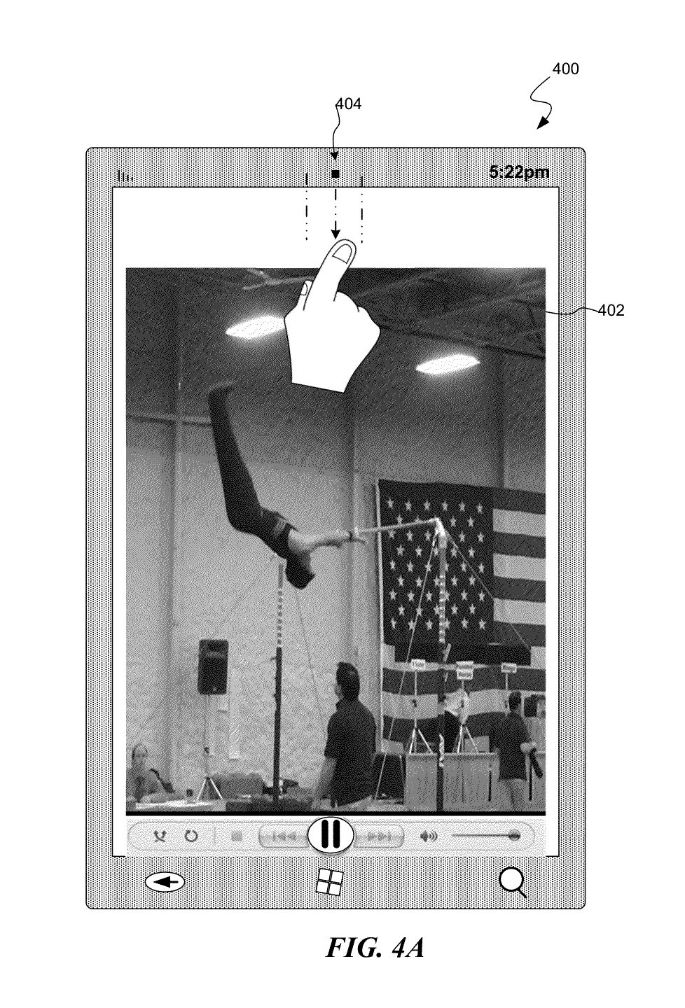

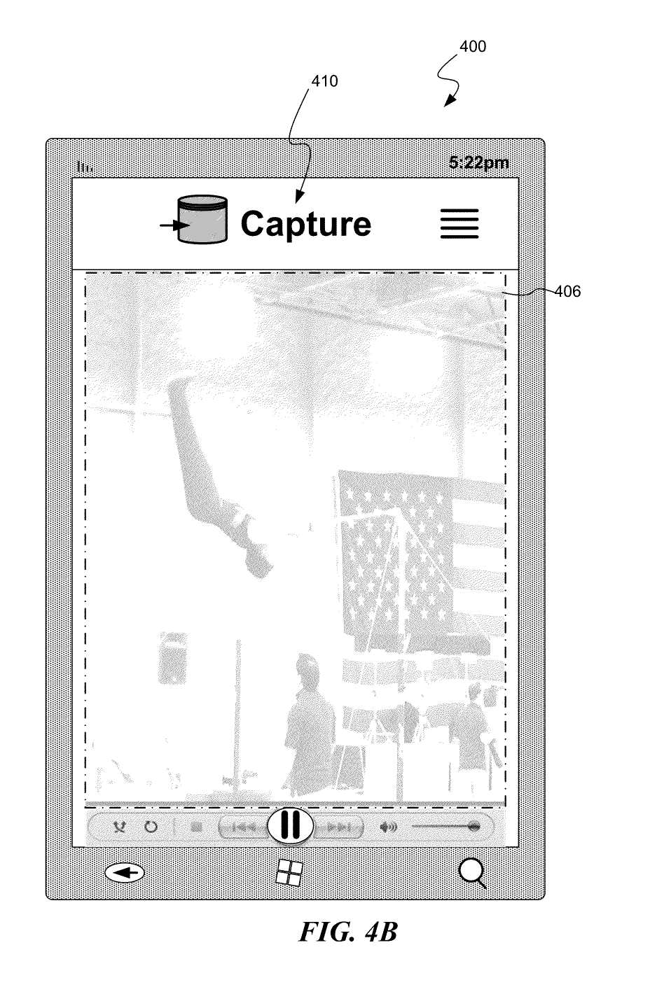

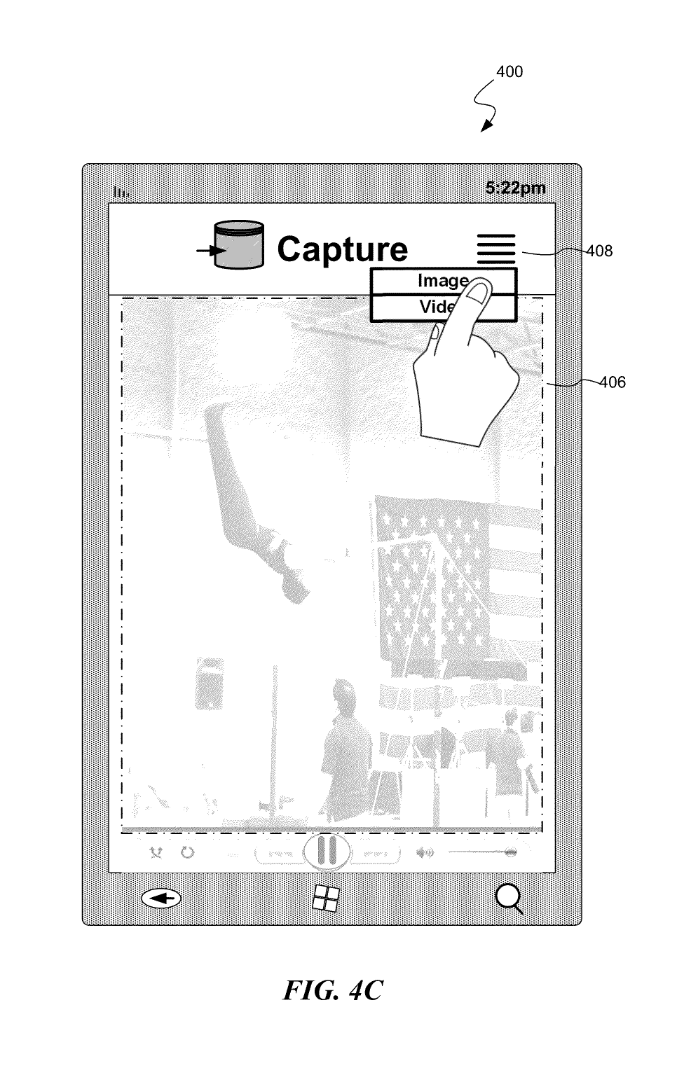

While FIGS. 3A and 3B illustrate one embodiment for interaction with the content capture process 104 and as suggested above, there may be any number of individual implementations for interacting with the content capture process. For example, FIGS. 4A-4C illustrate interaction with a content capture process 104 from a smart phone 400. In this example, and as shown in FIG. 4A, the smart phone 400 may be currently displaying a video 402. By touching and swiping down from an edge 404 of the display area, the content capture process 104 is invoked. According to aspects of the disclosed subject matter, in various embodiments upon invoking the content capture process 104 the display of content on the computing device is frozen, thus giving the user an opportunity to capture content without it being modified, cleared, or erased. As shown in FIG. 4B, as the content capture process 104 is invoked, the display of content is frozen and, in this example, is identified in a transparent capture box 406 indicating what content will be captured by this process. While not shown, a computer user may also be able to identify a selection of the content to be captured, e.g., through a “lasso” operation—identifying an area of content to be captured.

In addition to the capture box 406, the content capture process 104 (in this example) displays a capture control 410 as well as a configuration control 408. By selecting the capture control 410, the content displayed in the capture box 406 is stored in the content store 108. Typically, the content format that is captured is defaulted to the most robust version of the content. However, as shown in FIG. 4C, through a configuration control 408, the computer user may be presented with options to selectively identify the type of content to be captured. In the illustrated example, the computer user may selectively choose from capturing the video content that is being presented or a “snapshot” image of the image that is currently displayed in capture box 406.

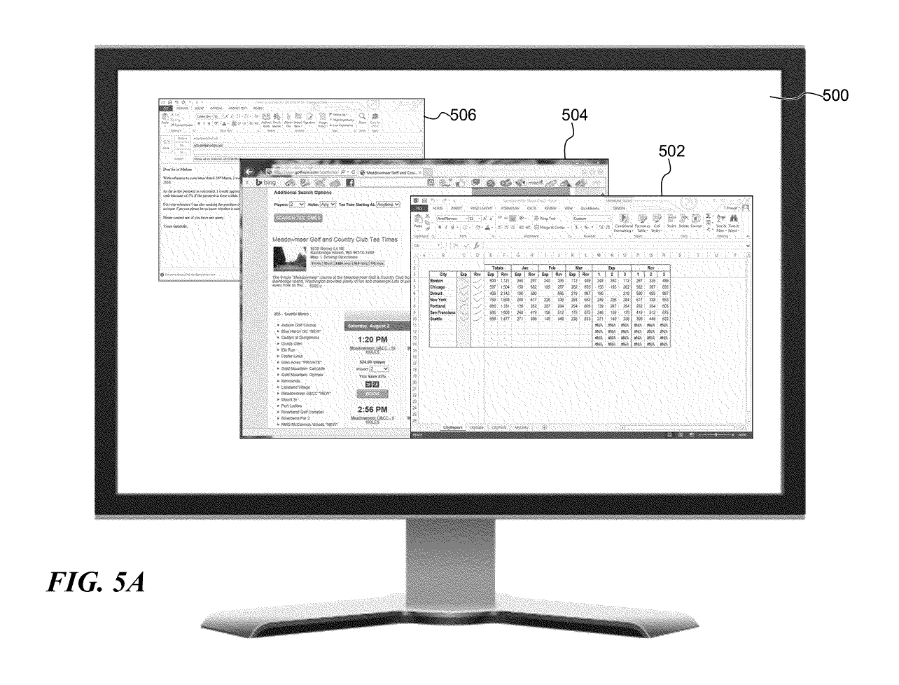

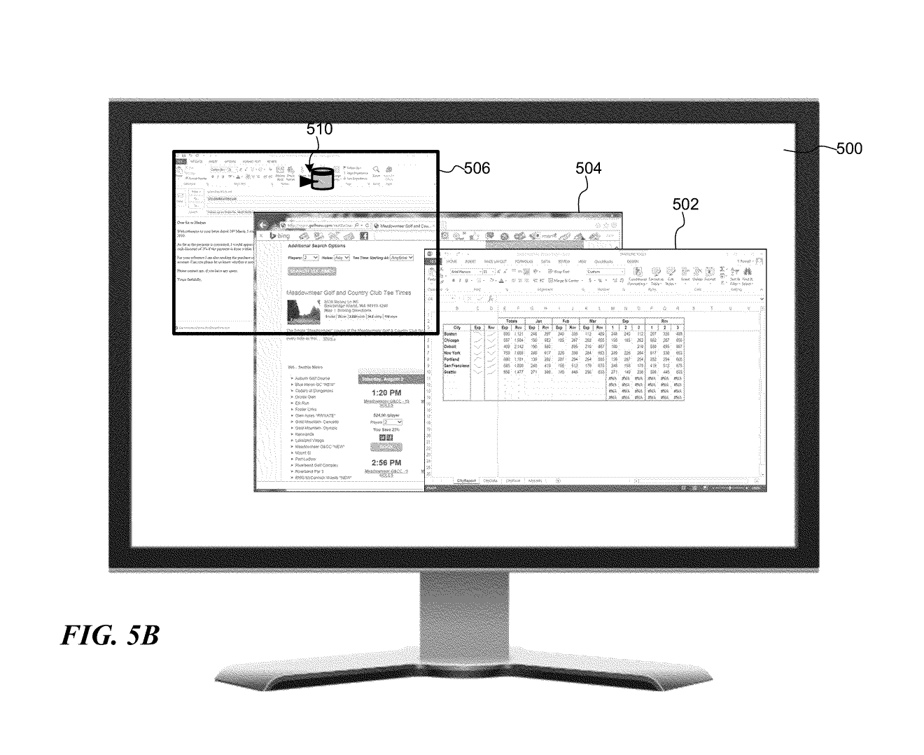

In yet another example, FIGS. 5A and 5B are pictorial diagrams illustrating the selection of content a display screen 500 of a computing device that includes a plurality of application views 502-506. For purposes of this example, the computing device is configured to trigger the content capture process according to a key-press sequence. Turning to FIG. 5B, this view of the display screen 500 is after the computer user has triggered the content capture process. As shown in this illustrative example, a selection indicator 510 can be positioned among the various application views to identify the source of content to be captured. As above, the output to the application views 502-506 is frozen, providing the computer user with an opportunity to capture a particular display of content or the underlying content. In the present example, by positioning over an application view, such as application view 506, the content capture service executing on the computing device highlights the border to indicate what content may be captured. In various embodiments, by releasing the selection indicator 510 over an application view, such as application view 506, indicates that the content of that corresponding application is to be captured. As a consequence, the content capture service may communicate with the selected application through an application programming interface (API) for obtaining content and metadata.

Turning now to FIG. 6, FIG. 6 is a block diagram illustrating an exemplary computing device 600 suitably configured with a content capture service which, in execution, comprises the content capture process as discussed above. The exemplary computing device 600 includes a processor 602 (or processing unit) and a memory 604, interconnected by way of a system bus 610. As will be readily appreciated, the memory 604 typically (but not always) comprises both volatile memory 606 and non-volatile memory 608. Volatile memory 606 retains or stores information so long as the memory is supplied with power. In contrast, non-volatile memory 608 is capable of storing (or persisting) information even when a power supply is not available. Generally speaking, RAM and CPU cache memory are examples of volatile memory 606 whereas ROM, solid-state memory devices, memory storage devices, and/or memory cards are examples of non-volatile memory 608.

The processor 602 executes instructions retrieved from the memory 604 in carrying out various functions, particularly in regard to capturing content into a content card index, providing an intelligent canvas, and providing an intelligent clipboard as described above. The processor 602 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: personal digital assistants, wearable computing devices, smart phone devices, tablet computing devices, smart phones, phablet computing devices, laptop computers, desktop computers, and the like.

The system bus 610 provides an interface for the various components of the mobile device to inter-communicate. The system bus 610 can be of any of several types of bus structures that can interconnect the various components (including both internal and external components). The exemplary computing system 600 further includes a network communication component 612 for interconnecting the computing device 600 with other network accessible computers, online services, and/or network entities as well as other devices on a computer network, such as network 120. The network communication component 612 may be configured to communicate with the various computers and devices over a network (not shown) via a wired connection, a wireless connection, or both.

Also included in the exemplary computing device 600 is an operating system 616 and one or more apps and/or applications 618, as well as a user I/O subsystem 614. As will be understood, the operating system (in execution) provides the basis for operating the computer, including the execution of additional apps and/or applications 618. The operating system 616 provides services for use by an app or application. Generally speaking, an operating system-level service is a service that operates as a service extension of an application or app. Often, though not exclusively, the operating system provides apps and applications with the services necessary to interact with the user I/O (Input/Output) subsystem 614, which includes the mechanisms by which the computer user interacts with apps and application on the computing device and the apps/applications are able to present information to the computer user.

The exemplary computing device 600 also includes a content capture component 620 which, in execution, comprises the content capture service 104 described above. As indicated above, the content capture service 104 is implemented as an operating system-level service (though not necessarily an element of the operating system) such that making use of the content capture service 104 does not require the change in execution context on the computing device, but is seen as a service extension for an app or application. As discussed above, the content capture service 104 stores or persists captured content in a content store 108. According to various non-exclusive embodiments, the content store is an indexed content store such that one or more keys (corresponding to key terms and information) serve as indices in a content index for locating and retrieving content from the content store. While the content store 108 is shown in FIG. 6 as being an element stored within the computing device 600, this is an illustrative embodiment and should not be construed as limiting upon the disclosed subject matter. As discussed above, the content store 108 may be located externally from the computing device 600 and/or implemented as an indexed storage service on a network 120.

Regarding the various components of the exemplary computing device 700, those skilled in the art will appreciate that these components may be implemented as executable software modules stored in the memory of the computing device, as hardware modules (including SoCs—system on a chip), or a combination of the two. Moreover, each of the various components may be implemented as an independent, cooperative process or device, operating in conjunction with or on one or more computer systems and or computing devices. It should be further appreciated, of course, that the various components described above in regard to the exemplary computing device 700 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for capturing content on a computing device, the method comprising:
detecting a user interaction on a computing device to capture content to a content store associated with a computer user operating the computing device; and
executing a content capture service to capture content to a content store, wherein executing the content capture service comprises:
notifying applications executing on the computing device to suspend output to display views corresponding to the applications;
identifying content of an application of the notified applications executing on the computing device as content to be captured to the content store;
obtaining the identified content from the application;
notifying the applications executing on the computing device to resume output to display views; and
automatically and without user interaction storing the obtained content in a content store associated with the computer user.

2. The computer-implemented method of claim 1, wherein the content capture service is an operating system-level service and wherein the identified content is obtained via an application programming interface for obtaining content.

3. The computer-implemented method of claim 2, wherein the content capture service is executed without changing the current execution context on the computing device.

4. The computer-implemented method of claim 1, wherein executing the content capture service further comprises obtaining metadata regarding the identified content and storing the metadata in the content store with the obtained content.

5. The computer-implemented method of claim 4, wherein the content store is remotely located from the computing device.

6. The computer-implemented method of claim 5, wherein the content store is hosted by a content store service operating on behalf of a plurality of computer users.

7. The computer-implemented method of claim 1, wherein the detected user interaction on the computing device comprises one or both of a gesture on a touch-sensitive surface of the computing device or a key-press combination on the computing device .

8. The computer-implemented method of claim 1, wherein identifying content of an application of the notified applications executing on the computing device as content to be captured to the content store comprises receiving an indication from the user identifying a portion of a body of content, the portion of content being the content to be captured to the content store.

9. The computer-implemented method of claim 1, wherein the detected user interaction on the computing device comprises an audio command detected by a sound-sensitive device that converts sound to one or more electronic signal.

10. The computer-implemented method of claim 1, wherein the detected user interaction on the computing device comprises an optically sensed action detected by an optical sensor that converts the optically sensed activity to one or more electronic signals.

11. The computer-implemented method of claim 1, wherein executing the content capture service further comprises determining a desired content format to be obtained from the application; and
wherein obtaining the identified content from the application via an application programming interface for obtaining content comprises obtaining the identified content from the application in the desired content format via an application programming interface.

12. A computer-readable medium bearing computer-executable instructions which, in execution on a computing device comprising at least a processor, carry out a method for capturing content on the computing device, the method comprising:
detecting a user interaction on a computing device to capture content to a content store associated with a computer user operating the computing device; and
executing a content capture service to capture content to a content store, wherein executing the content capture service comprises:
notifying applications executing on the computing device to suspend output to display views corresponding to the applications;
identifying content of an application of the notified applications executing on the computing device as content to be captured to the content store;
determining a desired content format to be obtained from the application and obtaining the identified content in the desired content format from the application via an application programming interface for obtaining content;
notifying the applications executing on the computing device to resume output to display views; and
automatically and without user interaction storing the obtained content in a content store associated with the computer user.

13. The computer-readable medium of claim 12, wherein the content capture service is an operating system-level service such that it executes without changing the current execution context on the computing device.

14. The computer-readable medium of claim 12, wherein executing the content capture service further comprises obtaining metadata regarding the identified content and storing the metadata in the content store with the obtained content.

15. The computer-readable medium of claim 14, wherein the content store is remotely located from the computing device.

16. The computer-readable medium of claim 15, wherein the content store is hosted by a content store service operating on behalf of a plurality of computer users.

17. The computer-readable medium of claim 15, wherein the detected user interaction on the computing device comprises any one of:
a gesture on a touch-sensitive surface of the computing device;
a key-press combination on the computing device;
a mouse-related interaction;
an audio command detected by a sound-sensitive device that converts sound to one or more electronic signal; and
an optically sensed action detected by an optical sensor that converts the optically sensed activity to one or more electronic signals.

18. A computing device for enhanced capturing content to a content store, the computing device comprising a processor and a memory, wherein the processor executes instructions stored in the memory as part of or in conjunction with additional components to capture content to a content store, the additional components comprising:
an executable content capture component configure to:
detect a user interaction on the computing device indicative of a computer user's intent to capture content to a content store associated with the computer user operating the computing device;
notify one or more applications executing on the computing device to suspend output to display views corresponding to the one or more applications;
identify content of an application of the notified applications executing on the computing device as content to be captured to the content store and obtain the identified content from the application via an application programming interface for obtaining content;
notify the one or more applications executing on the computing device to resume output to display views; and
automatically and without computer user interaction store the obtained content in a content store associated with the computer user.

19. The computing device of claim 18, wherein the detected user interaction comprises any one of:
a gesture on a touch-sensitive surface of the computing device;
a key-press combination on the computing device;
an audio command detected by a sound-sensitive device that converts sound to one or more electronic signal; and
an optically sensed action detected by an optical sensor that converts the optically sensed activity to one or more electronic signals.

20. The computing device of claim 18, wherein the executable content capture component is executed as an operating system-level service on the computing device such that it executes without changing the current execution context on the computing device.
